(19) United States
(12) Patent Application Publication
(10) Pub. No.: US 2026/0072548 A1
(43) Pub. Date: Mar. 12, 2026

(54) SYSTEM AND METHOD FOR TOUCH DISCRIMINATION USING CHANGES IN FORCE AND POSITION

(71) Applicant: Apple Inc., Cupertino, CA (US)

(72) Inventor: Benjamin EKEROTH, San Jose, CA (US)

(21) Appl. No.: 19/309,464

(22) Filed: Aug. 25, 2025

Related U.S. Application Data
(60) Provisional application No. 63/692,138, filed on Sep. 8, 2024.

(51) Int. Cl. G06F 3/041; G06F 3/044; G06F 3/0485; G06F 3/04883

(52) U.S. Cl. CPC G06F 3/04186; G06F 3/04166; G06F 3/0485; G06F 3/04883; G06F 3/0446

(57) ABSTRACT

Disclosed herein are systems and methods for disambiguating inputs provided to an input interface for an electronic device that includes both a plurality of touch sensors for determining a position of a touch input along the input interface as well as one or more force sensors for determining the magnitude of a force being applied to the input interface. In one or more examples, the one or more touch sensors and the one or more force sensors, either alone or in combination, can be used to disambiguate touch gestures (such as a swipe) being performed on the input interface from a force input (e.g., a press and/or tap) or other application of force on the input interface.

### CROSS REFERENCE TO RELATED APPLICATIONS

This application claims the benefit of U.S. Provisional Application No. 63/692,138, filed Sep. 8, 2024, the content of which is herein incorporated by reference in its entirety for all purposes.

### FIELD OF THE DISCLOSURE

This relates generally to the operation of capacitive touch sensor and force sensor for use in electronic devices to detect touch signals and changes in force being applied to an input interface associated with an electronic device.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular are popular because of their case and versatility of operation as well as their declining price. Touch screens can include a touch sensor panel, which can be a clear panel with a touch-sensitive surface, and a display device such as a liquid crystal display (LCD), light emitting diode (LED) display or organic light emitting diode (OLED) display that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electrical fields used to detect touch can extend beyond the surface of the display, and objects approaching near the surface may be detected near the surface without actually touching the surface. In some examples, a touch screen or touch sensor panel can detect touches by or proximity of multiple objects (e.g., one or more fingers or other touch objects), and such interactions can be used to perform various inputs using multiple objects. Such a touch screen or touch sensor panel may be referred to as a “multi-touch” touch screen or touch sensor panel, and may accept “multi-touch gestures” as inputs.

Capacitive touch sensor panels can be formed by a matrix of transparent, semi-transparent or non-transparent conductive plates made of materials such as Indium Tin Oxide (ITO). In some examples, the conductive plates can be formed from other materials including conductive polymers, metal mesh, graphene, nanowires (e.g., silver nanowires) or nanotubes (e.g., carbon nanotubes). In some implementations, due in part to their substantial transparency, some capacitive touch sensor panels can be overlaid on a display to form a touch screen, as described above. Some touch screens can be formed by at least partially integrating touch sensing circuitry into a display pixel stack-up (i.e., the stacked material layers forming the display pixels).

In some contexts, capacitive touch sensors can be implemented as self-capacitive touch sensors and can be used to detect the position of a finger or other applied input (e.g., stylus, etc.) along a surface of the electronic device. In some contexts, force sensors can be used on surfaces of the electronic device to detect forces being applied to the electronic device.

### SUMMARY OF THE DISCLOSURE

Examples of the disclosure are directed to an input interface for an electronic device that includes both a plurality of touch sensors for determining a position of a touch input along the input interface as well as one or more force sensors for determining the magnitude of a force being applied to the input interface. In one or more examples, the one or more touch sensors and the one or more force sensors, either alone or in combination, can be used to disambiguate touch gestures (such as a swipe) being performed on the input interface from a force input or other application of force on the input interface.

In some examples of the disclosure, in order to disambiguate a swipe gesture performed on the input interface from an initial “press” of the input interface (e.g., a user initially placing their finger on the input interface), the electronic device employs a single touch node heuristic to reject unintentional motion associated with a press that would otherwise be interpreted as a swipe gesture. In one or more examples, the single touch node heuristic includes rejecting movement of a contact on the input interface until the electronic device detects that at least one touch sensor of the plurality of touch sensors records a rise in the magnitude of a touch signal at the sensor followed by a subsequent decline in the magnitude of the touch signal, thereby indicating an intentional movement of the finger at the input interface.

In one or more examples, once the finger of the user has been detected as being on the input interface (e.g., via the touch and/or force sensors) the electronic device disambiguates press inputs from swipe gestures by determining a force rate and swipe rate from received touch sensor and force sensor data. For instance, in one or more examples, the electronic device determines a press input has been applied by the user when an accelerating force is detected as occurring after a decelerating touch. In some examples, the electronic device determines that a swipe gesture is being performed when an accelerating touch is detected as occurring after detecting of a decelerating force. In some examples, the electronic device determines that a press input is occurring when an accelerating touch is detected after an accelerating force has occurred. In some examples, the electronic device determines that a swipe input is occurring when an accelerating force is detected after an accelerating touch. In one or more examples, the above disambiguation heuristics allows support for users of the electronic device with any resting pressure level while still suppressing unintentional scrolls during a press operation.

In one or more examples, the electronic disambiguates a scroll input from a finger of the user lifting off the input interface without intending to scroll by determining whether or not a touch sensor magnitude on either side of a detected input is falling. In the event that both sides of an input are detected as falling, the electronic device determines that a lift off of the finger is occurring and does not perform a scroll operation on the device. In some examples, the electronic device disambiguates a lift off from an edge of the input interface from a scroll input by determining when a motion of the finger of the user accelerates with a rising magnitude of touch detected at a single touch sensor of the plurality of touch sensors (e.g., thus indicating a scroll operation is being performed).

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates a multi-touch sensing device used as an input device to a computer system in accordance with one or more examples of the disclosure.

FIG. 2 illustrates a plurality of contact patch areas corresponding to an object in proximity to a plurality of sense points of a multi-touch surface in accordance with one or more examples of the disclosure.

FIG. 3 illustrates a simplified schematic diagram of a mutual capacitance sensing circuitry that may be used in one or more examples of the disclosure.

FIG. 4 illustrates an exemplary electronic device that includes an input interface for receiving touch and/or force inputs according to examples of the disclosure.

FIG. 5 illustrates an exemplary input interface implementation according to examples of the disclosure.

FIG. 6 illustrates an exemplary press input at the input interface according to examples of the disclosure.

FIG. 7 illustrates an exemplary scroll touch input according to examples of the disclosure.

FIG. 8 illustrates an exemplary process for disambiguating a scroll input from an initial contact with the input interface according to examples of the disclosure.

FIG. 9 illustrates an exemplary process for disambiguating a continuous press input from a scroll input at the input interface according to examples of the disclosure.

FIG. 10 illustrates another exemplary process for disambiguating a continuous press input from a scroll input at the input interface according to examples of the disclosure.

FIG. 11 illustrates another exemplary process for disambiguating a continuous press input from a scroll input at the input interface according to examples of the disclosure.

FIG. 12 illustrates another exemplary process for disambiguating a continuous press input from a scroll input at the input interface according to examples of the disclosure.

FIG. 13 illustrates an exemplary process for disambiguating a scroll input from a release of a press input according to examples of the disclosure.

FIG. 14 illustrates an exemplary edge scroll operation according to examples of the disclosure.

FIG. 15 illustrates an exemplary edge lift off according to examples of the disclosure.

FIG. 16 illustrates an exemplary flow chart for disambiguating a touch input from a press input according to examples of the disclosure.

FIG. 17 illustrates a computing system including a touch screen according to examples of the disclosure.

### DETAILED DESCRIPTION

Examples of the disclosure are directed to an input interface for an electronic device that includes both a plurality of touch sensors for determining a position of a touch input along the input interface as well as one or more force sensors for determining the magnitude of a force being applied to the input interface. In one or more examples, the one or more touch sensors and the one or more force sensors, either alone or in combination, can be used to disambiguate touch gestures (such as a swipe) being performed on the input interface from a force input or other application of force on the input interface.

In some examples of the disclosure, in order to disambiguate a swipe gesture performed on the input interface from an initial “press” of the input interface (e.g., a user initially placing their finger on the input interface), the electronic device employs a single touch node heuristic to reject unintentional motion associated with a press that would otherwise be interpreted as a swipe gesture. In one or more examples, the single touch node heuristic includes rejecting movement of a contact on the input interface until the electronic device detects that at least one touch sensor of the plurality of touch sensors records a rise in the magnitude of a touch signal at the sensor followed by a subsequent decline in the magnitude of the touch signal, thereby indicating an intentional movement of the finger at the input interface.

In one or more examples, once the finger of the user has been detected as being on the input interface (e.g., via the touch and/or force sensors) the electronic device disambiguates press inputs from swipe gestures by determining a force rate and swipe rate from received touch sensor and force sensor data. For instance, in one or more examples, the electronic device determines a press input has been applied by the user when an accelerating force is detected as occurring after a decelerating touch. In some examples, the electronic device determines that a swipe gesture is being performed when an accelerating touch is detected as occurring after detecting of a decelerating force. In some examples, the electronic device determines that a press input is occurring when an accelerating touch is detected after an accelerating force has occurred. In some examples, the electronic device determines that a swipe input is occurring when an accelerating force is detected after an accelerating touch. In one or more examples, the above disambiguation heuristics allows support for users of the electronic device with any resting pressure level while still suppressing unintentional scrolls during a press operation.

In one or more examples, the electronic disambiguates a scroll input from a finger of the user lifting off the input interface without intending to scroll by determining whether or not a touch sensor magnitude on either side of a detected input is falling. In the event that both sides of an input are detected as falling, the electronic device determines that a lift off of the finger is occurring and does not perform a scroll operation on the device. In some examples, the electronic device disambiguates a lift off from an edge of the input interface from a scroll input by determining when a motion of the finger of the user accelerates with a rising magnitude of touch detected at a single touch sensor of the plurality of touch sensors (e.g., thus indicating a scroll operation is being performed).

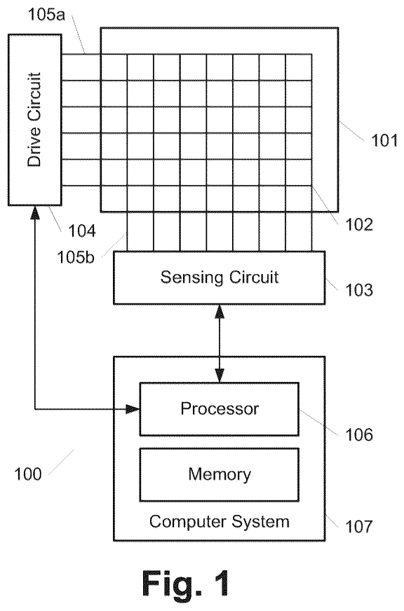

Recognizing multiple simultaneous or near-simultaneous touch events may be accomplished with a multi-touch sensing arrangement as illustrated in FIG. 1. Multi-touch sensing arrangement 100 can detect and monitor multiple touch attributes (including, for example, identification, position, velocity, size, shape, and magnitude) across touch-sensitive surface 101, at the same time, nearly the same time, at different times, or over a period of time. Touch-sensitive surface 101 can provide a plurality of sensor points, coordinates, or nodes 102 that function substantially independently of one another and that represent different points on a touch sensitive surface. Sensing points 102 may be positioned in a grid or array, with each sensing point capable of generating a signal at the same time. Sensing points 102 may be considered as mapping touch-sensitive surface 101 into a coordinate system, for example, a Cartesian or polar coordinate system.

A touch sensitive surface may, for example, be in the form of a tablet or a touch screen. To produce a touch screen, the capacitance sensing points and other associated electrical structures can be formed with a substantially transparent conductive medium, such as indium tin oxide (ITO). The number and configuration of sensing points 102 may be varied. The number of sensing points 102 generally depends on the desired resolution and sensitivity. In touch-screen applications, the number of sensing points 102 may also depend on the desired transparency of the touch screen.

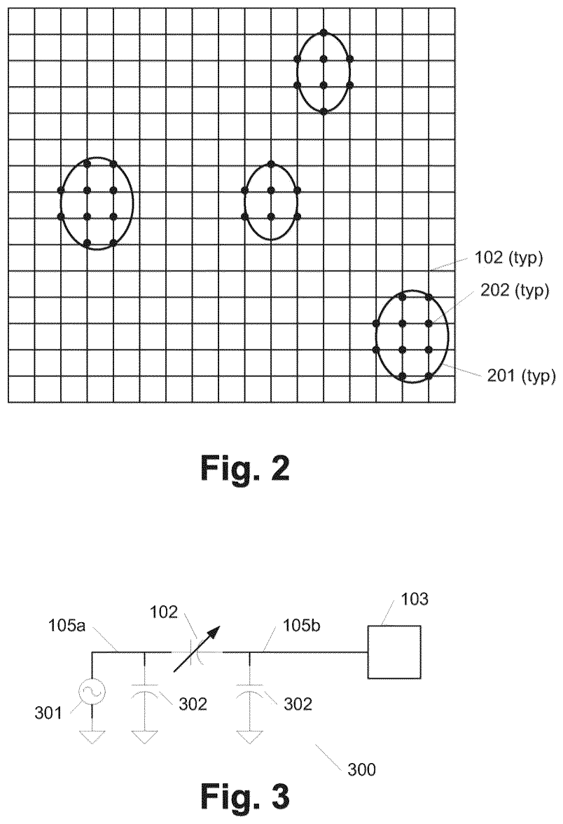

Using a multi-touch sensing arrangement, like that described in greater detail below, signals generated at nodes 102 of touch-sensitive surface 101 may be used to produce an image of the touches at a particular point in time. For example, each object (e.g., finger, stylus, etc.) in contact with or in proximity to touch-sensitive surface 101 can produce contact patch area 201, as illustrated in FIG. 2. Each of contact patch area 201 may cover several nodes 102. Covered nodes 202 may detect the object, while remaining nodes 102 do not. As a result, a pixilated image of the touch surface plane (which may be referred to as a touch image, a multi-touch image, or a proximity image) can be formed. The signals for each contact patch area 201 may be grouped together. Each contact patch area 201 may include high and low points based on the amount of touch at each point. The shape of contact patch area 201, as well as the high and low points within the image, may be used to differentiate contact patch areas 201 that are in close proximity to one another. Furthermore, the current image can be compared to previous images to determine how the objects may be moving over time, and what corresponding action should be performed in a host device as a result thereof.

Many different sensing technologies can be used in conjunction with these sensing arrangements, including resistive, capacitive, optical, etc. In capacitance-based sensing arrangements, as an object approaches touch-sensitive surface 101, a small capacitance forms between the object and sensing points (e.g., nodes) 102 in proximity to the object. By detecting changes in capacitance at each of the sensing points 102 caused by this small capacitance, and by noting the position of the sensing points, a sensing circuit 103 (also referred to as sensing circuitry) can detect and monitor multiple touches. The capacitive sensing nodes may be based on self-capacitance or mutual capacitance.

In self-capacitance systems, the “self” capacitance of a sensing point is measured relative to some reference, e.g., ground. Sensing points 102 may be spatially separated electrodes. These electrodes are coupled to driving circuitry 104 and sensing circuitry 103 by conductive traces (drive lines 105a) and (sense lines 105b). In some self-capacitance examples, a single conductive trace to each electrode may be used as both a drive and sense line.

In mutual capacitance systems, the “mutual” capacitance between a first electrode and a second electrode can be measured. In mutual capacitance sensing arrangements, the sensing points may be formed by the crossings of patterned conductors forming spatially separated lines. For example, drive lines 105a may be formed on a first layer and sense lines 105b may be formed on a second layer such that the drive and sense lines cross or “intersect” one another at sensing points 102. The different layers may be different substrates, different sides of the same substrate, or the same side of a substrate with some dielectric separation. Because the drive and sense lines are separated, there is a capacitive coupling node at each “intersection.”

The manner in which the drive and sense lines are arranged may vary. For example, in a Cartesian coordinate system (as illustrated), the drive lines may be formed as horizontal rows, while the sense lines may be formed as vertical columns (or vice versa), thus forming a plurality of nodes that may be considered as having distinct x and y coordinates. Alternatively, in a polar coordinate system, the sense lines may be a plurality of concentric circles with the drive lines being radially extending lines (or vice versa), thus forming a plurality of nodes that may be considered as having distinct r and angle coordinates. In either case, drive lines 105a may be connected to driving circuitry 104, and sense lines 105b may be connected to sensing circuitry 103.

During operation, a drive signal (e.g., a periodic voltage) is applied to each drive line 105a. When driven, the charge impressed on drive line 105a can capacitively couple to the intersecting sense lines 105b through nodes 102. This can cause a detectable, measurable current and/or voltage in sense lines 105b. The relationship between the drive signal and the signal appearing on sense lines 105b is a function of the capacitance coupling the drive and sense lines, which, as noted above, may be affected by an object in proximity to node 102. Capacitance sensing circuitry (e.g., one or more sensing circuits) 103 may sense sense lines 105b and may determine the capacitance at each node as described in greater detail below.

As discussed above, some single-stimulation signals drive drive lines 105a one at a time, while the other drive lines were grounded. This process was repeated for each drive line 105a until all the drive lines had been driven, and a touch image (based on capacitance) was built from the sensed results. Once all the drive lines 105a had been driven, the sequence would repeat to build a series of touch images. However, in some examples of the present disclosure, multiple drive lines may be driven simultaneously or nearly simultaneously, as described, for example, below. As used herein, “simultaneously” encompasses precisely simultaneous as well as nearly simultaneous events. For example, simultaneous events may begin at about the same time, end at about the same time, and/or take place over at least partially overlapping time periods.

FIG. 3 illustrates a simplified schematic diagram of mutual capacitance circuit 300 corresponding to the arrangement described above. Mutual capacitance circuit 300 may include drive line 105a and sense line 105b, which are spatially separated thereby forming capacitive coupling at nodes 102. Drive line 105a may be electrically (i.e., conductively) coupled to driving circuitry 104 represented by voltage source 301. Sense line 105b may be electrically coupled to capacitive sensing circuitry 103. Both drive line 105a and sense line 105b may, in some cases, include some parasitic capacitance 302.

As noted above, in the absence of a conductive object proximate the intersection of drive line 105a and sense line 105b, the capacitive coupling at node 102 stays fairly constant. However, if an electrically conductive object (for example, a user's finger, stylus, etc.) comes in proximity to node 102, the capacitive coupling (i.e., the capacitance of the local system) changes. The change in capacitive coupling changes the current (and/or voltage) carried by sense line 105b. Capacitance sensing circuitry 103 may note the capacitance change and the position of node 102 and report this information in some form to processor 106 (FIG. 1).

With reference to FIG. 1, sensing circuitry 103 may acquire data from touch-sensitive surface 101 and supply the acquired data to processor 106. In some examples, sensing circuitry 103 may be configured to send raw data (e.g., an array of capacitance values corresponding to each sense point 102) to processor 106. In other examples, sensing circuitry 103 may be configured to process the raw data itself and deliver processed touch data to processor 106. In either case, the processor may then use the data it receives to control operation of computer system 107 and/or one or more applications running thereon. Various implementations along these lines are described in the applications referenced above, and include a variety of computer systems having touch pads and touch screens.

In some examples, sensing circuitry 103 may include one or more microcontrollers, each of which may monitor one or more sensing points 102. The microcontrollers may be application specific integrated circuits (ASICs), that work with firmware to monitor the signals from touch-sensitive surface 101, process the monitored signals, and report this information to processor 106. The microcontrollers may also be digital signal processors (DSPs). In some examples, sensing circuitry 103 may include one or more sensor ICs that measure the capacitance in each sense line 105b, and report measured values to processor 106 or to a host controller (not shown) in computer system 107. Any number of sensor ICs may be used. For example, a sensor IC may be used for all lines, or multiple sensor ICs may be used for a single line or group of lines.

In some examples, a touch sensor panel such as the one described above with respect to FIGS. 1-3 above, while able to accurately detect touch inputs, can in some instances require the user to use multiple hands in order to apply a touch input. For instance, a first hand of the user can be used to hold the device, while a second hand of the user can be used to apply a touch input to the touch sensor panel. Thus, in some examples, even to perform simple operations on an electronic device such as scrolling visual content that is displayed on a display of the electronic device, the user is required to use both hands. In some examples, an electronic device can include a capacitive touch sensor (in addition to the touch sensor panel) that is in a form factor that does not require two hands to hold the device in order to apply a touch input to the electronic device, and furthermore is not part of a touch sensor panel that is integrated with a display of an electronic device. In some examples, and as described below, the capacitive touch sensor can be part of an input interface that can include a force sensor that is part of the input interface (but is a separate sensor from the capacitive touch sensor).

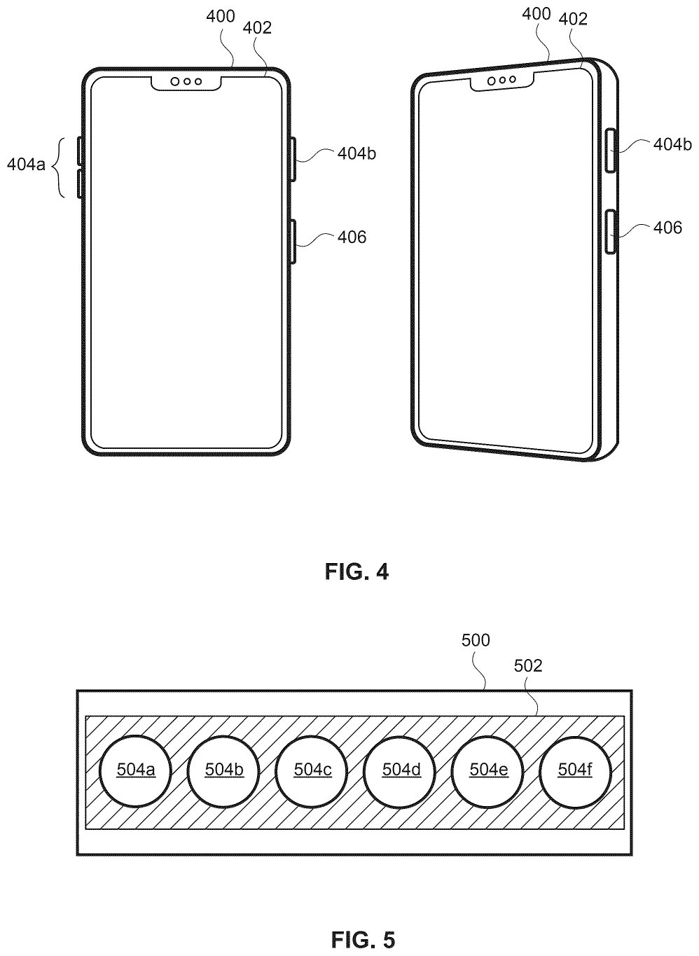

FIG. 4 illustrates an exemplary electronic device that includes an input interface for receiving touch and/or force inputs according to examples of the disclosure. In some examples, electronic device 400 (which in the example of FIG. 4 is illustrated as a mobile computing device but should not be seen as limiting to the disclosure) includes a display/touch sensor panel 402 implemented according to the examples described above with respect to FIGS. 1-3, and one or more input buttons 404a-b. In some examples, input buttons 404a-b are implemented as mechanical buttons that are configured to receive push inputs (e.g., a push of the button) and convert the mechanical input into an electrical signal that is then interpreted by the electronic device 400 to perform one or more operations on the electronic device. For instance, input buttons 404a-b can be utilized to power on/off electronic device 400, and/or increase/decrease the volume outputted by electronic device 400. In one or more examples, electronic device can include an input interface 406. As described in further detail below, input interface 406 can be configured to receive a touch input/gesture that can be utilized to perform various operations on the electronic device. For example, input interface 406 can be utilized to perform one or more scrolling operations on the device in response to a touch input that changes position over time, with the scrolling operation being commensurate with the change in position of the touch input over time.

In one or more examples, input interface 406 can be also configured to receive and interpret push inputs and/or force inputs that can then be interpreted to perform various operations on the electronic device such as a selecting operation on the electronic device. For instance, in one example, input interface 406 can be configured to accept a touch input to perform a scrolling operation to scroll through a menu of options on a user interface, and can also accept a push input/force input that can be interpreted to select an option from the menu options based on the current scroll position of the menu of options.

In one or more examples, the input interface 406 of electronic device can be implemented as an integrated interface that includes a plurality of touch sensors that collectively can be used to determine a position and direction of a touch input along the input interface 406, and one or more force sensors that can detect a force being applied to the input interface 406. In one or more examples, the touch sensors and the force sensors are implemented as separate sensors that can be integrated onto the input interface 406.

FIG. 5 illustrates an exemplary input interface implementation according to examples of the disclosure. In one or more examples, input interface 500 of FIG. 5 illustrates an exemplary implementation of the input interface 406 described above with respect to the example electronic device 400 of FIG. 4. In one or more examples, the input interface includes a plurality of touch sensors 504a-f. In the example of FIG. 4, the input interface 500 is illustrated as having six touch sensors 504a-f, but the disclosure should not be seen as limiting, and an input interface 500 could include more or fewer touch sensors. In one or more examples, each touch sensor 504a-f is implemented as a self-capacitance touch sensor that is configured to measure not only the presence of a touch input at the sensor but is also configured to register a magnitude of a touch input that is proportional to the proximity of a touch input to the touch sensor. For instance, in one or more examples, and as described in further detail below, a touch sensor such as touch sensor 504a in the example input interface 500 of FIG. 5 registers a peak magnitude touch signal when a touch is being applied directly on the sensor (e.g., the entirety of the sensor is being touched by a finger of the user), and the magnitude of the touch signal reduces as the finger moves away from touch sensor 504a, until finally the magnitude of the touch is returned to zero due to the finger no longer being in proximity to touch sensor 504a. As described in further detail below, the increasing and decreasing magnitudes registered at each of touch sensors 504a-f can be detected by electronic device 400 and used to determine the position and direction of a touch input (which in turn can be used to determine whether a user is performing a scrolling operation or other operation that involves moving a touch input across the user interface). In one or more examples, touch sensors 504a-f are disposed across a length of the input interface 500 such that a touch signal is generated whenever the user touches any portion of the input interface 500.

In one or more examples, input interface 500 includes a force sensor 502 that is configured to register a force signal in response to a force being applied to the input interface 500. In one or more examples, force sensor 502 can be implemented as a single sensor as illustrated in FIG. 5, such that the force sensor 502 registers or generates a force signal in response to a force input (e.g., the user applying a force input to the input interface 500) that is proportional to the amount of force being applied to the input interface 500 no matter where on input interface 500 the force is applied. Alternatively, input interface 500 can include multiple force sensors that are disposed at various locations on the input interface, and the multiple force sensors can be used to determine not only the amount of force being applied to the input interface 500, but also the location on the input interface 500 where the force is being applied.

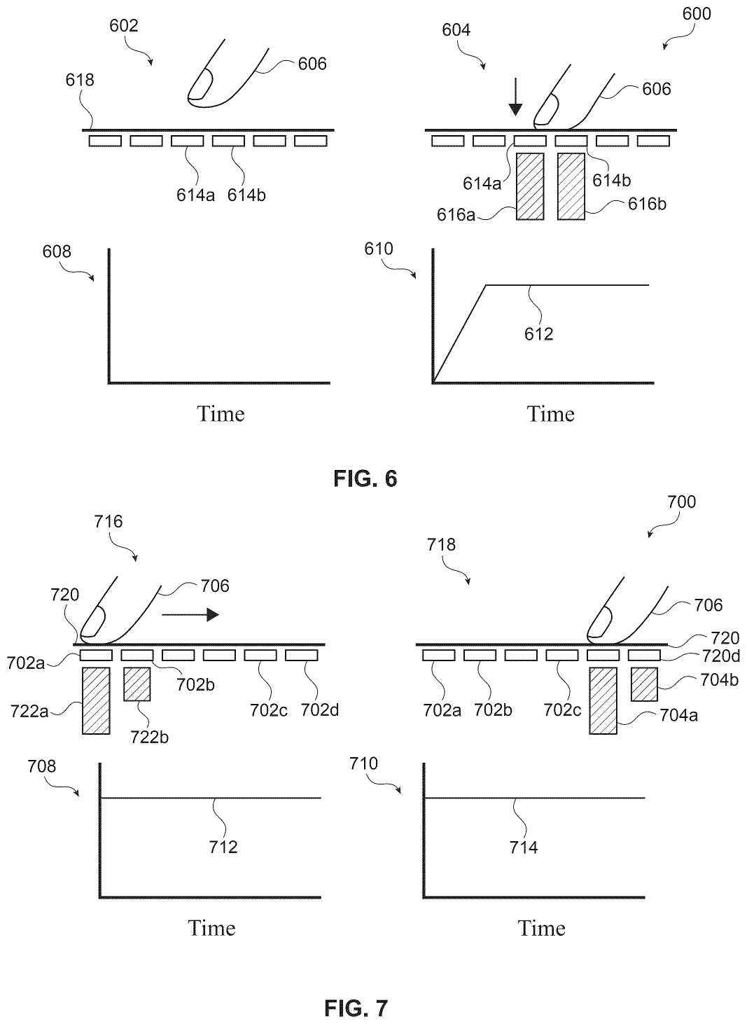

In one or more examples, force sensor 502 can be utilized by the electronic device to determine when an input applied to input interface 500 (e.g., by a finger of the user of the electronic device) is a press input that is being applied by the user and in response perform an operation on the electronic device associated with a press input. For instance, and as described in further detail below, if the magnitude of the force registered at force sensor 502 is above a threshold amount of force, then in response, the electronic device performs an operation that is associated with a press input as described below with respect to FIG. 6.

FIG. 6 illustrates an exemplary press input at the input interface according to examples of the disclosure. In one or more examples, the example 600 of FIG. 6 illustrates a press input being applied to the input interface 618. In one or more examples, at time instance 602 (e.g., a first instance of time), the user of the electronic device moves finger 606 towards the input interface 618 without touching the input interface 618 (e.g., without making contact with the input interface 618). In some examples, at time instance 602, because the finger is not touching or applying a force to the input interface 618, no signal is detected at the force sensor or any of the touch sensors (since the finger is not in close enough proximity to any of the touch sensors). Thus, as illustrated in example 600, the force vs. time graph 608 at time instance 602 is zero, and the magnitude of a signal at touch sensors 614a-b (the two touch sensors in closest proximity to finger 606) is also zero.

In one or more examples, as finger 606 makes contact with the input interface 618, as illustrated at time instance 604, both the force sensor and the touch sensors of the input interface 618 generate force signals and touch signals. For instance, in response to finger 606 making contact with the input interface 618 and in response to finger 606 continuing to push down on input interface 618, the force sensor generates a force signal that increases over time and that eventually settles to a steady value as show by the force curve 612 of the force v. time graph 610 of example 600. In some examples, the force curve 612 settles to a steady state value either because the force sensor has been pushed beyond its maximum possible value and/or because the user has stopped increasing the force of the force sensor. In one or more examples, when the force curve rises above a threshold value, the electronic device determines that a press input has been applied to the input interface and performs an operation that is associated with the press input.

As shown in example 600, in response to finger 606 coming into near proximity and/or in contact with input interface 618, touch sensors 614a and 614b generate touch signals 616a and 616b respectively even though the user is not performing a touch input (e.g., moving their finger along the surface of input interface 618). As described in further detail below, the electronic device can use the changing signals at the force sensors and the one or more touch sensors to determine whether an input at the input interface is a touch input, a press input, and/or both.

In one or more examples, a touch input can be detected by the one or more touch sensors (described above with respect to FIG. 5) to determine if the user is performing a swipe gesture (such as a scroll input) at the input interface. In some examples, as the touch sensors are disposed across the length of an input interface, the electronic device determines motion of a finger across the input interface by determining not only the presence of touch signals at the touch sensors, but also the direction in which the touch is moving by analyzing the acceleration and deceleration of touch signals across the input interface as described below.

FIG. 7 illustrates an exemplary swipe gesture according to examples of the disclosure. The example 700 of FIG. 7 illustrates an exemplary swipe gesture that begins on a first side of the input interface and terminates on the opposite side of the input interface. In one or more examples, example 700 begins at a first time instance 716 in which the finger 706 of the user is making contact with a first side of input interface 720. In one or more examples, because finger 706 is on the first side of input interface 720, touch sensors 702a and 702b generate a touch signal that is read by the electronic device. As illustrated in FIG. 7, the magnitude 722a of the touch signal at touch sensor 702a is higher than the magnitude 722b of the touch signal at touch sensor 702b due to the finger 706 being directly over (e.g., in closer proximity) to touch sensor 702a than touch sensor 702b. As illustrated, the remaining touch sensors (for example touch sensors 702c and 702d) do not generate a touch signal since the proximity of finger 706 to touch sensors 702c and 702d is too far away for the sensors to register/generate a touch signal in response to finger 706.

In one or more examples, as finger 706 moves across input interface 720, finger 706 become proximal to other touch sensors of the input interface 720, while moving away from touch sensors 702a-b as illustrated at time instance 718. At time instance 718, finger 706 has moved from the first side of the input interface 720 to the other side opposite the first side. Thus, as shown in time instance 718, touch sensors 702c and 702d generate touch signals with a magnitude 704a and 704b respectively, due to the proximity of finger 706 to those touch sensors (e.g., touch sensors 702a and 702b see an accelerating/rising touch signal) while touch sensors 702a and 702b no longer generate a touch signal due to finger 706 having moved away from the touch sensors (e.g., touch sensor 702a and 702 see a decelerating touch signal until finally the touch signal at each sensor goes to zero). As illustrated, the magnitude 708a of the touch signal at touch sensor 704c is greater than the magnitude 704b of the touch signal at touch sensor 704d due to finger 706 being directly over touch sensor 704c (e.g., in closer proximity) and adjacent to touch sensor 704d.

In one or examples, electronic device can determine that a swipe gesture (e.g., that the user intends to move their finger across the input interface 720) by determining that the touch signals generated by the touch sensors on one side of the input interface 720 (e.g., touch sensors 702a and 702d) are decelerating (e.g., decreasing in magnitude while simultaneously the touch signals on the opposite side of the input interface (e.g., touch sensors 702c and 702d) are accelerating (e.g., increasing in magnitude). In one or more examples, and ideally, when the user is intending to perform a swipe gesture on the input interface, the user applies uniform pressure with finger 706 while the scroll gesture is being performed. For instance, in the example 700 of FIG. 7, the force v. time graphs 708 and 710 of time instances 716 and 718 respectively show a constant pressure being applied to the input interface 720 as illustrated by force curves 712 and 714.

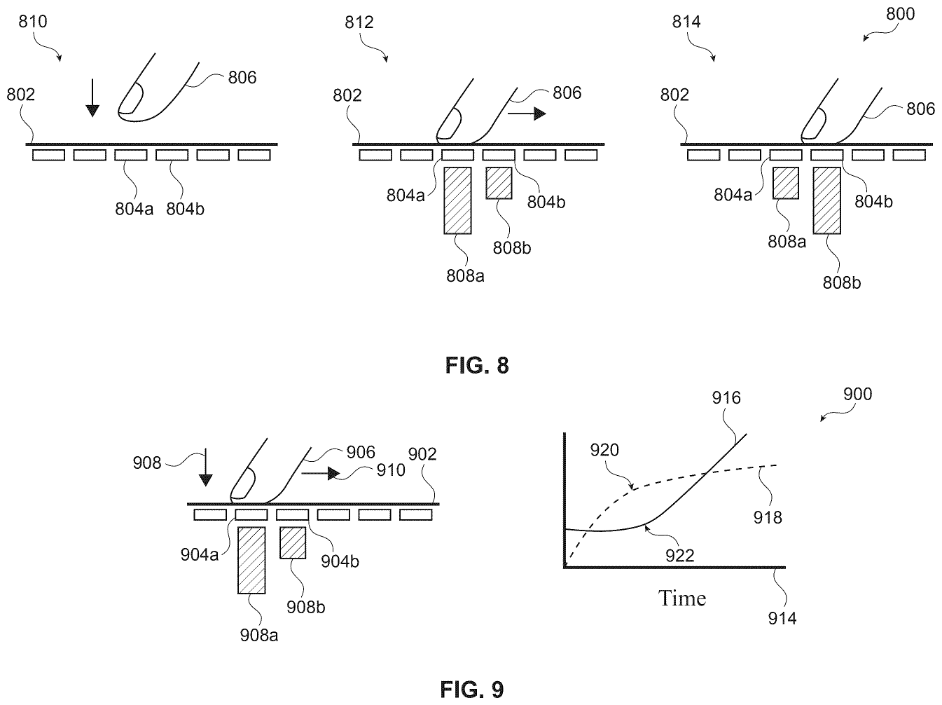

In one or more examples, and even though the user of the electronic intends to perform a press input at the input interface, the touch sensors of the input interface will register both accelerating and decelerating touch signals that could be interpreted as swipe gestures. Thus, in one or more examples, the electronic device uses one or more heuristics to disambiguate scroll inputs from press inputs and/or uses one or more heuristics to perform a scroll operation in response to changes observed in the one or more touch signals and the force signals over time while the user is interacting with the input interface as described below with respect to FIGS. 8-16.

FIG. 8 illustrates an exemplary process for disambiguating a swipe gesture from an initial contact with the input interface according to examples of the disclosure. In one or more examples, as the user brings finger 806 in proximity to (and without touching) input interface 802 at first time instance 810. In one or more examples, touch sensors 804a and 804b initially do not generate touch signals because finger 806 is too far away for the sensors to register a touch signal. However, in one or more examples, when finger 806 initially makes contact with the input interface at second time instance 812 (which comes later in time than time instance 810), touch sensors 804a and 804 generate accelerating touch signals (e.g., rising touch signals) as finger 806 comes into closer proximity with those sensors.

In some examples, without a set of heuristics to interpret the rising/accelerating touch signals at touch sensors 804a and 804b, the rising/accelerating touch signals could be interpreted as the beginning of a scroll operation (e.g., as if the finger 806 were moving from left to right instead of from above). Thus, in one or more examples, and in order disambiguate a scroll operation from an initial contact with the input interface 802, the electronic device forgoes performing a scroll operation until observing a rising/accelerating touch signal at a touch sensor followed by a falling/decelerating touch signal at the same touch sensor. For instance, as illustrated in example 800, at time instance 814 (which occurs later in time than time instance 812), as finger 806 slides across the input interface from its initial position at time instance 812, the magnitude 808a of the touch signal at touch sensor 804a goes from accelerating at time instance 812 to decelerating at time instance 814 due to the motion of finger 806 away from touch sensor 804a. Thus, in one or more examples, the electronic device can initiate a scroll operation in response to observing an acceleration of the magnitude 808a of the touch signal at touch sensor 804a followed by a deceleration of the magnitude 808a of the touch signal at touch sensor 804a.

In one or more examples, the direction of the scroll operation can be dependent on which touch sensor exhibits an accelerating touch signal while touch sensor 804a exhibits a decelerating touch signal. For instance, as shown at time instance 814, touch sensor 804b exhibits an accelerating touch signal (e.g., magnitude 808b is rising) as touch sensor 804a exhibits a decelerating touch signal (e.g., magnitude 808a is falling) thus indicating that the swipe gesture is moving from left to right. Thus, in one or more examples, the electronic device can perform the scroll operation in accordance with the detected direction of the swipe gesture.

In one or more examples, once a finger of the user has engaged with input interface (e.g., is actively making contact with the input interface), the device can interpret data from the touch sensors and/or force sensors to determine whether or not detected changes in the position of the finger are to be interpreted as a swipe gesture. As described below, the electronic device employs a series of heuristics based on the force rate and touch movement rate of the finger (as determined by the force sensor and touch sensor data) to determine whether to perform a scroll operation in response to both a changing force sensor reading and changing touch sensor readings.

FIG. 9 illustrates an exemplary process for disambiguating a continuous press input from a scroll input at the input interface according to examples of the disclosure. In the example 900 of FIG. 9, finger 906 is contacting (e.g., touching) input interface 902. In one or more examples, finger 906 simultaneously applies a downward force 908 that causes an accelerating force input at a force sensor of the input interface and also applies a side movement 910 that causes a moving touch signal to sweep across the touch sensors, including touch sensors 904a and 904b. In one or more examples, in order to disambiguate whether the side movement 910 of the finger 906 is intentional (e.g., the user of the electronic device is performing a swipe gesture) or if the movement 910 of the finger 906 is inadvertent and the user is performing a press input, the electronic device determines a relationship between the acceleration of the force signal caused by the downward force 908 and the movement of the touch signal caused by the side movement 910 and based on the determined relationship, determines whether to perform a scroll operation or not in response to movement 910 of the finger.

In the example 900 of FIG. 9, using the touch sensor signals being generated at each of the touch sensors (such as touch sensor 904a and 904b), the computer system determines the change in position of the finger 906 across the input interface 902 as illustrated by curve 918 at graph 914. In some examples, curve 918 represents the position of the finger 906 as a function time. Similarly, the electronic device determines the change in the force being applied to the force sensor as illustrated by curve 916. Based on the relationship between the acceleration/deceleration of the movement of the finger 906 (e.g., curve 918) and the acceleration/deceleration of the force being applied by finger 906 to the force sensor (e.g., curve 916) the electronic device determines whether to perform a scroll operation or forgo performing a scroll operation in response to the movement 910 of the finger across the input interface 902. In the example 900 of FIG. 9, the finger 906 decelerates in terms of position (e.g., the rate of change in the position of the finger slows down) at point 920 on curve 918, prior to the electronic device detecting the force accelerating at point 922 on curve 916. Thus, in response to detecting an accelerating force after a decelerating touch, the electronic device performs a press operation and/or forgoes performing a scroll operation. In one or more examples, an accelerating force after a decelerating touch can indicate that the movement 910 of finger 906 may be inadvertent and caused by the user suddenly performing a press input rather than an intentional swipe gesture. Thus, in the example 900 of FIG. 9, even though the device detects motion of the finger 906 commensurate with a swipe gesture, the electronic device can reject the swipe gesture (e.g., not perform a scroll operation in response) because the motion of the finger decelerated prior to the force accelerating as described above.

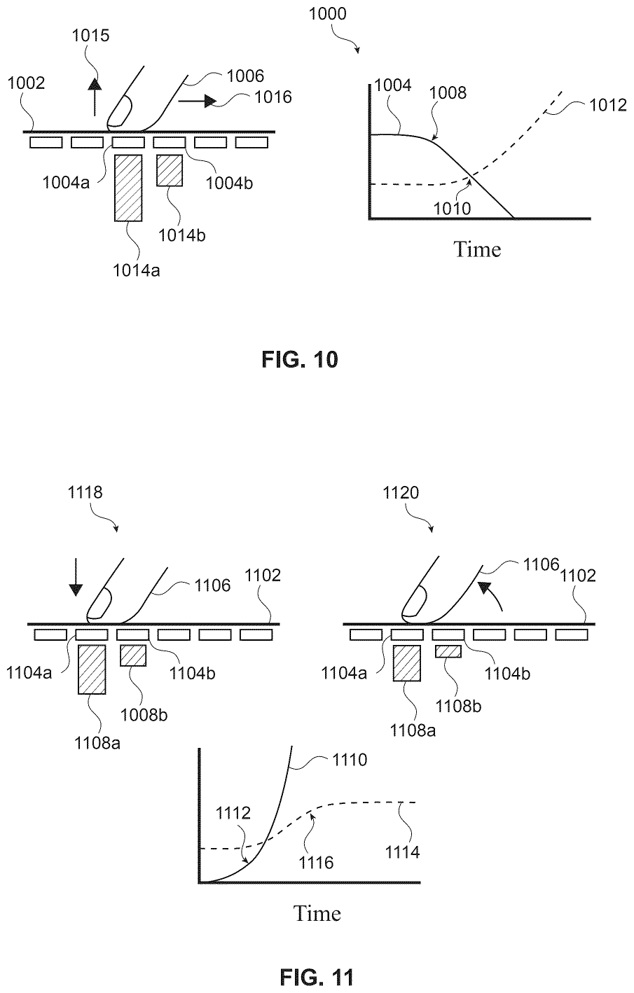

FIG. 10 illustrates another exemplary process for disambiguating a continuous press input from a scroll input at the input interface according to examples of the disclosure. In the example 1000 of FIG. 10, finger 1006 simultaneously moves in direction 1016 while also lifting up (e.g., decreasing the force of the input as shown at 1014) on the input interface 1002. In one or more examples, the electronic device determines that a swipe gesture is being performed and in response performs a scroll operation when the deceleration of the force (shown at point 1008 on force curve 1004) occurs prior to an acceleration in the movement of the touch signal (shown at point 1010 of position curve 1012). Thus, when the electronic device determines that there is an accelerating touch (e.g., the rate of movement of the touch is increasing) after a decelerating force signal, the electronic device determines that the user is performing a swipe gesture (e.g., intentionally moving finger 10006 across the input interface 1002) and in response performs a scroll operation. In some examples, an acceleration in movement of the finger after a deceleration force is indicative of the user releasing force to perform a swipe gesture.

FIG. 11 illustrates another exemplary process for disambiguating a continuous press input from a scroll input at the input interface according to examples of the disclosure. In the example of FIG. 11, the finger 1106 initially applies a downward force to the input interface 1102 which causes an acceleration in the force sensor data, and then performs a finger roll (e.g., adjusting the placement of the finger on the input interface 1102 without moving a position of the finger 1106) which can cause a change in the touch sensor data that could mimic a swipe (even though no swipe was intended). For instance, as shown in the example 1100 of FIG. 11, when the finger 1106 initially presses down at time instance 1118, the magnitude 1108a of touch sensor 1104a and the magnitude 1108b of touch sensors 1104b register a first value. In one or more examples, as finger 1106 rolls such that less of the finger 1106 is in contact with input interface 1102, the magnitude 1108b of touch sensor 1104b decreases as shown at time instance 1120. In some examples, the decrease in the magnitude 1108b of touch sensor 1104 can appear as motion of finger 1106. In some examples, in order to disambiguate the press input and finger roll from a swipe gesture, the electronic device performs a press operation upon detecting an accelerating touch signal after an accelerating force signal, which is indicative of a press input followed by a finger roll or other adjustment of the finger that is not a swipe input.

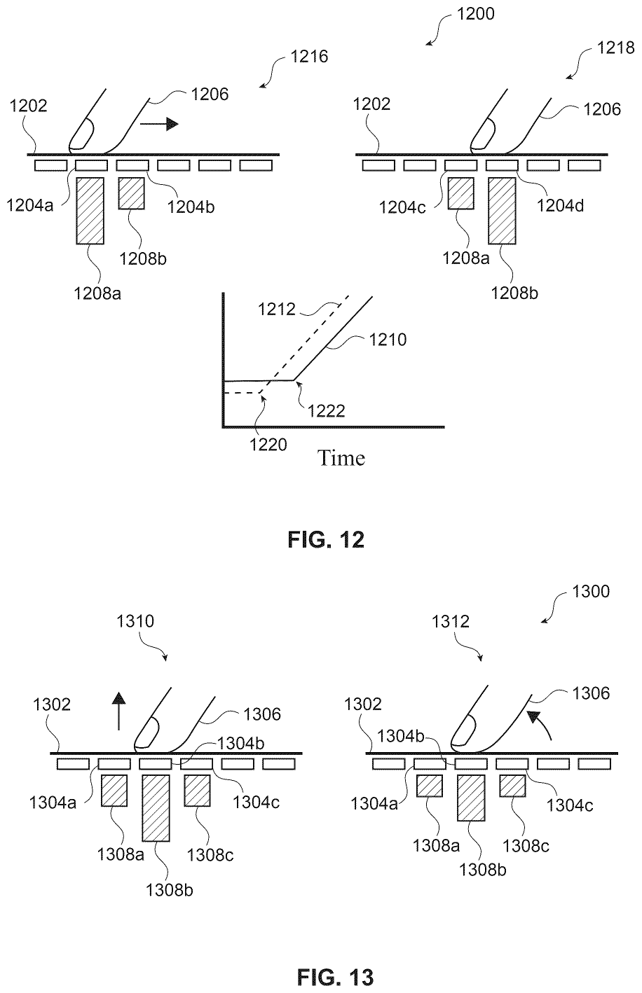

FIG. 12 illustrates another exemplary process for disambiguating a continuous press input from a swipe gesture at the input interface according to examples of the disclosure. In one or more examples, a change in force applied by the finger can be caused by friction experienced by the finger as it performs a swipe gesture. In the example 1200 of FIG. 12, finger 1206 performs a swipe gesture that begins at time instance 1216 and ends at time instance 1218. In one or more examples, finger 1206a begins at touch sensor 1204a and 1204b (e.g., causing the touch sensors to generate a magnitude 1208a and 1208b respectively) moves across input interface 1202, and finally at time instance 1218 moves to touch sensor 1204c and 1204d (thus causing the touch sensors to generate a magnitude 1208c and 1208d respectively).

In some examples, finger 1206 moves across input interface 1202, friction between the finger 1106 and the input interface 1202 can cause the force sensor to generate an accelerating force signal that could be falsely interpreted as a press input. Thus, in one or more examples, in order to disambiguate a swipe gesture from a press input in the context of friction causing an increase in a force input, the electronic device determines that a swipe gesture has been performed and rejects a press input when it detects an accelerating force that occurs after a detecting an acceleration touch. For instance, as shown in example 1200 of FIG. 12, the touch sensor curve 1212 accelerates (at point 1220) prior to the force sensor curve 1210 accelerating (at point 1222). Thus, in response to detecting the acceleration of the touch (e.g., the position of the touch) occurring prior to the acceleration of the force, the electronic device performs a scroll operation and rejects a press input.

FIG. 13 illustrates an exemplary process for disambiguating a scroll input from a release of a press input according to examples of the disclosure. In the example 1300 of FIG. 13, finger 1306 while in contact with input interface 1302, initiates a lift off from input interface 1302 (e.g., begins to move the finger up and off of input interface 1302). In one or more examples, as the finger initiates the lift off at time instance 1310, the finger 1106 of the user may move slightly during the lift off process. For instance, as shown at time instance 1312, the area of finger 1316 that is in contact with the input interface 1302 decreases because the finger is rolling to a point before lifting off of the input interface 1302.

In one or more examples, the motion of finger 1306 can mimic a swipe gesture. For instance, as shown at time instance 1310, the magnitude 1308a, 1308b, and 1308c of touch sensors 1304a, 1304b, and 1304c, respectively has a first value. In one or more examples, the electronic device can determine that touch sensor 1304b is a center of the contact of finger 1306 at input interface 1302, based on magnitudes 1308a, 1308b, and 1308c (for instance because magnitude 1308b is the highest magnitude of the three magnitudes the electronic device can determine that the center of the contact is located at touch sensor 1304b).

In one or more examples, the electronic device can disambiguate a lift off from a swipe gesture by determining that a touch sensor magnitude on either side of the center of contact is falling, and in response rejecting a scroll operation (e.g., forgo performing a scroll operation). For instance, as illustrated at time instance 1312, magnitude 1308a associated with touch sensor 1304a, and magnitude 1308c associated with touch sensor 1304c decrease in value (as compared with time instance 1310) due to finger 1306 rolling off the input interface. In one or more examples, the electronic device can determine that the changes in magnitude on either side of the center of contact (e.g., the touch sensor signals falling on either side of the center of the contact) are not part of a swipe gesture and thus reject a scroll operation (e.g., forgo performing a scroll operation).

In one or more examples, an edge lift off, and swipe gesture that is being performed off the edge of an input interface can have similar motion characteristics as detected by the touch sensors disposed at the input interface. Thus, in one or more examples, and as described in further detail below, the electronic device uses the current state of an input at the input interface to disambiguate an edge swipe and an edge lift off

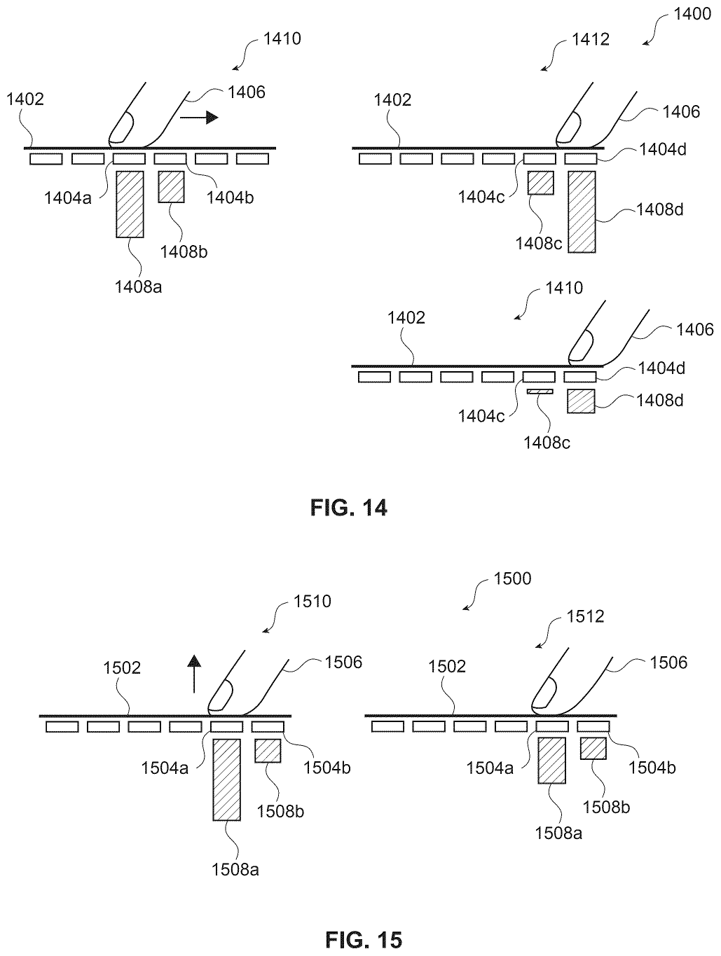

FIG. 14 illustrates an exemplary edge swipe gesture according to examples of the disclosure. In the example 1400 of FIG. 14, finger 1406 is performing a swipe gesture (described above) that moves toward and finally the edge of the input interface 1402. For instance, at time instance 1410, finger 1406 begins a swipe gesture at a position on input interface 1402 where touch sensor 1404a is located and thus touch sensor 1404a generates a touch signal with magnitude 1408a and a touch signal with magnitude 1408b at touch sensor 1404b (since touch sensor 1404b is also proximal to finger 1406). In one or more examples, the electronic device detects that finger 1406 is moving and in response performs a scroll operation similar to the examples described above.

In one or more examples, and as illustrated at time instance 1412, when the finger approaches the edge of the input interface 1402, the touch signals generated in response to finger 1406 begin to decrease in magnitude. For instance, as shown at time instance 1412 when finger 1406 is at the edge of the input interface 1402, it generates touch signals with magnitudes 1408c and 1408d at touch sensors 1404c and 1404d respectively. In one or more examples, as finger 1406 continues to move over the edge of input interface 1402, the touch signals at touch sensors 1404c and 1404d reduce further (without any additional touch sensors seeing a rise in touch signal). For instance, as shown at time instance 1414 the touch signal at touch sensor 1408c has reduced to zero while the touch signal at touch sensor 1408d has reduced to nearly zero.

In one or more examples, an edge lift off can exhibit similar characteristics to a swipe gesture that is performed at an edge of the input interface. FIG. 15 illustrates an exemplary edge lift off according to examples of the disclosure. In the example 1500 of FIG. 15 finger 1506 is at edge of input interface 1502 without moving across the input interface (e.g., the finger is stopped at the edge and is not otherwise in the middle of a swipe input). In one or more examples, at time instance 1510 finger 1506 is initiating a lift off at the edge of the input interface but is still in contact with input interface 1502 and thus generates touch signals at touch sensors 1504a and 1504b with magnitudes 1508a and 1508b respectively.

In one or more examples, and as illustrated at time instance 1512 (which is later in time during the edge lift off from time instance 1510), the magnitude 1508a and 1508b of the touch signals at touch sensors 1504a and 1504b reduce because finger 1506 is moving away (in a vertical direction) from the input interface 1502. In one or more examples, the electronic device disambiguates an edge swipe from an edge lift off by propagating the state of the input prior to detecting the decrease in magnitude of the edge touch sensors. For instance, returning to the example of FIG. 14, because the electronic device was already engaged in a swipe gesture (e.g., performing a scroll operation) when the magnitude 1408c and 1408d of touch sensors 1404c and 1404d were detected as decreasing, the electronic device can continue to perform the scroll operation under an assumption that finger 1406 is scrolling off the edge of the input interface 1402. However, in the example 1500 of FIG. 15, because the electronic device had detected that the finger 1506 was not in motion, in response detecting the decrease in magnitudes 1508a and 1508b of the touch signals at touch sensors 1504a and 1504 will forgo performing a scroll operation.

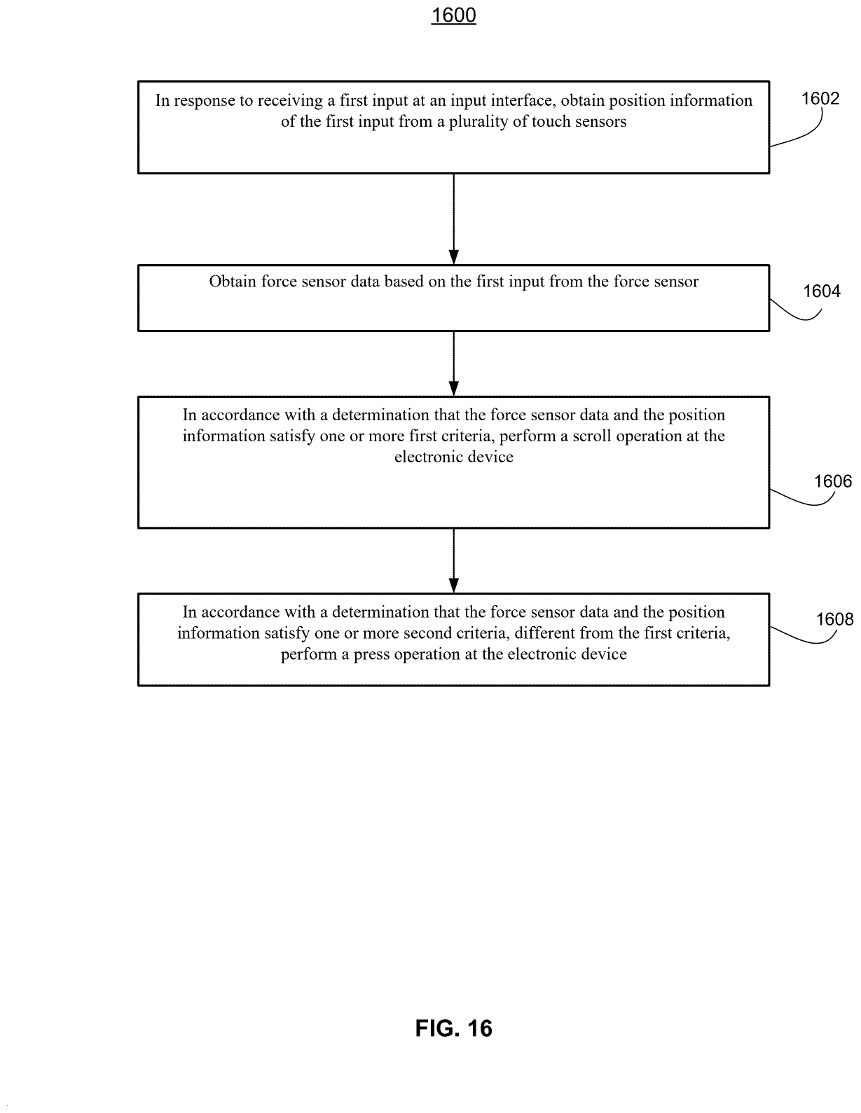

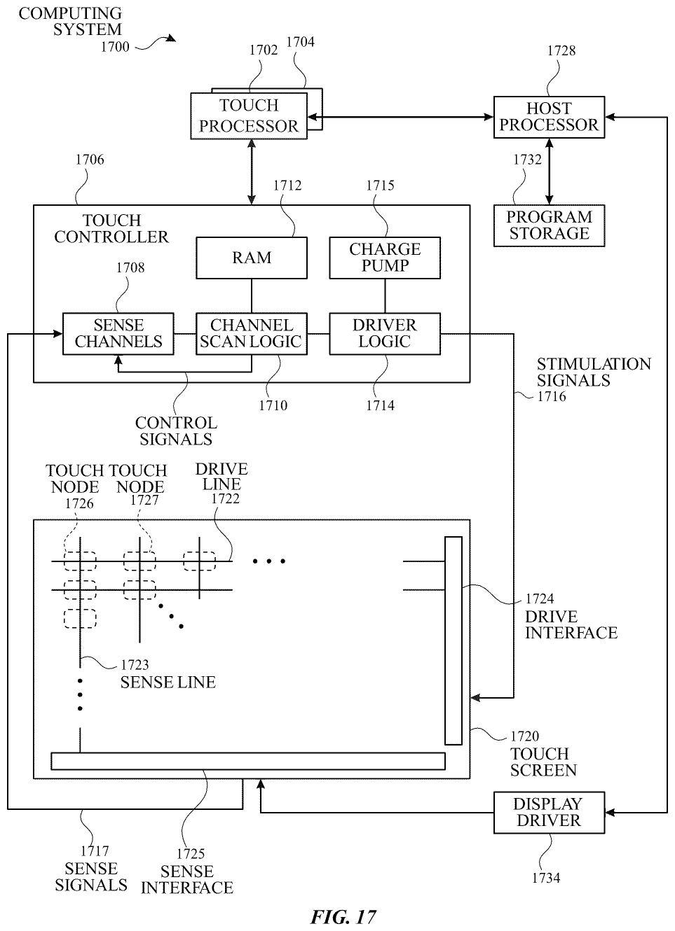

FIG. 16 illustrates an exemplary flow chart for disambiguating a touch input from a press input according to examples of the disclosure. In one or more examples, at an electronic device that includes an input interface, wherein the input interface includes a plurality of touch sensors and a force sensor: in response to receiving a first input at the input interface, the electronic device obtains (1602) position information of the first input from the plurality of touch sensors. In some examples, in response to the first input the electronic device obtains (1604) force sensor data based on the first input from the force sensor. In one or more examples, in accordance with a determination that the force sensor data and the position information satisfy one or more first criteria, the electronic device performs (1606) a scroll operation at the electronic device. In one or more examples, in accordance with a determination that the force sensor data and the position information satisfy one or more second criteria, different from the first criteria, the electronic device performs (1608) a press operation at the electronic device.

In some examples, the first input is an initial contact with the input interface, and the one or more first criteria, include a criterion that is satisfied when the electronic device detects a rising magnitude of touch at a first touch sensor of the one or more touch sensors, followed by a falling magnitude of touch at the first touch sensor.

In one or more examples, the electronic device further determines a touch acceleration state from the position information, and determines a force acceleration state from the force sensor data.

In one or more examples, the one or more second criteria include a criterion that is satisfied in accordance with a determination that the touch acceleration state is in a deacceleration state prior to a determination that the force acceleration state is in an acceleration state.

In one or more examples, the one or more second criteria include a criterion that is satisfied in accordance with a determination that the force acceleration state is in an acceleration state prior to a determination that the touch acceleration state is in an acceleration state.

In one or more examples, the one or more first criteria include a criterion that is satisfied in accordance with a determination that the force acceleration state is in a deacceleration state prior to a determination that the touch acceleration state is in an acceleration state.

In one or more examples, the one or more first criteria include a criterion that is satisfied in accordance with a determination that the touch acceleration state is in an acceleration state prior to a determination that the force acceleration state is in an acceleration state.

In one or more examples, the electronic device determines a spatial center of the first input based on the position information, and the one or more first criteria include a criterion that is not satisfied in accordance with a determination that a magnitude of a first touch sensor of the plurality of touch sensors on a first side of the spatial center of the first input is decreasing and a magnitude of a second touch sensor of the plurality of touch sensors on a second side of the spatial center of the first input, different from the first side, is decreasing.

In one or more examples, while performing the scroll operation, the electronic device in accordance with a determination that one or more touch sensors of the plurality of touch sensors associated with an edge portion of the input interface receives a decreasing touch signal, continues the scrolling operation.

In one or more examples, and while the electronic device is not performing a scroll operation: in accordance with a determination that the one or more touch sensors of the plurality of touch sensors associated with the edge portion of the input interface receives a decreasing touch signal, the electronic device forgoes performing a scrolling operation.

In one or more examples, the plurality of touch sensors are self-capacitive touch sensors.

FIG. 17 illustrates an example computing system including a touch screen according to examples of the disclosure, although it should be understood that the illustrated touch screen 1720 (which includes a touch sensor panel) could instead be a touch sensor panel (e.g., without a screen). Computing system 1700 can be included in, for example, a mobile phone, tablet, touchpad, portable or desktop computer, portable media player, wearable device or any mobile or non-mobile computing device that includes a touch screen or touch sensor panel. Computing system 1700 can include a touch sensing system including one or more touch processors 1702, peripherals 1704, a touch controller 1706, and touch sensing circuitry (described in more detail below). Peripherals 1704 can include, but are not limited to, random access memory (RAM) or other types of memory or storage, watchdog timers and the like. Touch controller 1706 (e.g., corresponding to driving circuitry 104 and sensing circuitry 103) can include, but is not limited to, one or more sense channels 1708, channel scan logic 1710 and driver logic 1714. Channel scan logic 1710 can access RAM 1712, autonomously read data from the sense channels, and provide control for the sense channels. In addition, channel scan logic 1710 can control driver logic 1714 to generate stimulation signals 1716 at various frequencies and/or phases that can be selectively applied to drive regions of the touch sensing circuitry of touch screen 1720, as described herein. In some instances, touch controller 1706, touch processor 1702 and peripherals 1704 can be integrated into a single application specific integrated circuit (ASIC), and in some instances can be integrated with touch screen 1720 itself. The example computing system 1700 of FIG. 17 can be configured to implement and perform any of the scans described herein.

It should be apparent that the architecture shown in FIG. 17 is one example architecture of computing system 1700, and that the system could have more or fewer components than shown, or a different configuration of components. In some instances, computing system 1700 can include an energy storage device (e.g., a battery) to provide a power supply and/or communication circuitry to provide for wired or wireless communication (e.g., cellular, Bluetooth, Wi-Fi, etc.). The various components shown in FIG. 17 can be implemented in hardware, software, firmware, or any combination thereof, including one or more signal processing and/or application specific integrated circuits.

Computing system 1700 can include a host processor 1728 for receiving outputs from touch processor 1702 and performing actions based on the outputs. For example, host processor 1728 can be connected to program storage 1732 and a display controller/driver 1734 (e.g., a Liquid-Crystal Display (LCD) driver). It should be understood that although some examples of the disclosure may be described with reference to LCD displays, the scope of the disclosure is not so limited and can extend to other types of displays, such as Light-Emitting Diode (LED) displays, including Organic LED (OLED), Active-Matrix Organic LED (AMOLED) and Passive-Matrix Organic LED (PMOLED) displays. Display driver 1734 can provide voltages on select (e.g., gate) lines to each pixel transistor and can provide data signals along data lines to these same transistors to control the pixel display image.

Host processor 1728 can use display driver 1734 to generate a display image on touch screen 1720, such as a display image of a user interface (UI), and can use touch processor 1702 and touch controller 1706 to detect a touch on or near touch screen 1720, such as a touch input to the displayed UI. The touch input can be used by computer programs stored in program storage 1732 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1728 can also perform additional functions that may not be related to touch processing.

Note that one or more of the functions described in this disclosure can be performed by firmware stored in memory (e.g., one of the peripherals 1704 in FIG. 17) and executed by touch processor 1702, or stored in program storage 1732 and executed by host processor 1728. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. In some instances, RAM 1712 or program storage 1732 (or both) can be a non-transitory computer readable storage medium. One or both of RAM 1712 and program storage 1732 can have stored therein instructions, which when executed by touch processor 1702 or host processor 1728 or both, can cause the device including computing system 1700 to perform one or more functions and methods of one or more examples of this disclosure. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate, or transport the program for use by or in connection with the instruction execution system, apparatus, or device. The transport medium can include, but is not limited to, an electronic, magnetic, optical, electromagnetic, or infrared wired or wireless propagation medium.

Touch screen 1720 can be used to derive touch information at multiple discrete locations of the touch screen, referred to herein as touch nodes. Touch screen 1720 can include touch sensing circuitry that can include a capacitive sensing medium having a plurality of drive lines 1722 and a plurality of sense lines 1723 (e.g., corresponding to drive lines 105a and sense lines 105b). It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 1722 can be driven by stimulation signals 1716 from driver logic 1714 through a drive interface 1724, and resulting sense signals 1717 generated in sense lines 1723 can be transmitted through a sense interface 1725 to sense channels 1708 in touch controller 1706. In this way, drive lines and sense lines can be part of the touch sensing circuitry that can interact to form capacitive sensing nodes, which can be thought of as touch picture elements (touch nodes) and referred to herein as touch nodes, such as touch nodes 1726 and 1727. This way of understanding can be particularly useful when touch screen 1720 is viewed as capturing an “image” of touch (“touch image”). In other words, after touch controller 1706 has determined whether a touch has been detected at each touch nodes in the touch screen, the pattern of touch nodes in the touch screen at which a touch occurred can be thought of as an “image” of touch (e.g., a pattern of fingers touching the touch screen). As used herein, an electrical component “coupled to” or “connected to” another electrical component encompasses a direct or indirect connection providing electrical path for communication or operation between the coupled components. Thus, for example, drive lines 1722 may be directly connected to driver logic 1714 or indirectly connected to driver logic 1714 via drive interface 1724 and sense lines 1723 may be directly connected to sense channels 1708 or indirectly connected to sense channels 1708 via sense interface 1725. In either case an electrical path for driving and/or sensing the touch nodes can be provided.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device that includes an input interface, wherein the input interface includes a plurality of touch sensors and a force sensor:
in response to receiving a first input at the input interface:
obtaining position information of the first input from the plurality of touch sensors;
obtaining force sensor data based on the first input from the force sensor;
in accordance with a determination that the force sensor data and the position information satisfy one or more first criteria, performing a scroll operation at the electronic device; and
in accordance with a determination that the force sensor data and the position information satisfy one or more second criteria, different from the first criteria, performing a press operation at the electronic device.

2. The method of claim 1, wherein the first input is an initial contact with the input interface, and wherein:
the one or more first criteria include a criterion that is satisfied when the electronic device detects a rising magnitude of touch at a first touch sensor of the one or more touch sensors, followed by a falling magnitude of touch at the first touch sensor.

3. The method of claim 1, wherein the method further comprises:
determining a touch acceleration state from the position information; and
determining a force acceleration state from the force sensor data.

4. The method of claim 3, wherein:
the one or more second criteria include a criterion that is satisfied in accordance with a determination that the touch acceleration state is in a deacceleration state prior to a determination that the force acceleration state is in an acceleration state.

5. The method of claim 3, wherein the one or more second criteria include a criterion that is satisfied in accordance with a determination that the force acceleration state is in an acceleration state prior to a determination that the touch acceleration state is in an acceleration state.

6. The method of claim 3, wherein the one or more first criteria include a criterion that is satisfied in accordance with a determination that the force acceleration state is in a deacceleration state prior to a determination that the touch acceleration state is in an acceleration state.

7. The method of claim 3, wherein the one or more first criteria include a criterion that is satisfied in accordance with a determination that the touch acceleration state is in an acceleration state prior to a determination that the force acceleration state is in an acceleration state.

8. The method of claim 1, wherein the method further comprises:
determining a spatial center of the first input based on the position information; and
wherein the one or more first criteria include a criterion that is not satisfied in accordance with a determination that a magnitude of a first touch sensor of the plurality of touch sensors on a first side of the spatial center of the first input is decreasing and a magnitude of a second touch sensor of the plurality of touch sensors on a second side of the spatial center of the first input, different from the first side, is decreasing.

9. The method of claim 1, wherein the method further comprises:
while performing the scroll operation:
in accordance with a determination that one or more touch sensors of the plurality of touch sensors associated with an edge portion of the input interface receives a decreasing touch signal, continuing the scrolling operation.

10. The method of claim 9, wherein the method further comprises:
while the electronic device is not performing a scroll operation:
in accordance with a determination that the one or more touch sensors of the plurality of touch sensors associated with the edge portion of the input interface receives a decreasing touch signal, forgoing performing a scrolling operation.

11. An electronic device comprising:
an input interface, wherein the input interface includes a plurality of touch sensors and a force sensor;
one or more processors;
memory; and
one or more programs, wherein the one or more programs are stored in the memory and configured to be executed by the one or more processors, the one or more programs including instructions for:
in response to receiving a first input at input interface:
obtaining position information of the first input from the plurality of touch sensors;
obtaining force sensor data based on the first input from the force sensor;
in accordance with a determination that the force sensor data and the position information satisfy one or more first criteria, performing a scroll operation at the electronic device; and
in accordance with a determination that the force sensor data and the position information satisfy one or more second criteria, different from the first criteria, performing a press operation at the electronic device.

12. The electronic device of claim 11, wherein the first input is an initial contact with the input interface, and wherein:
the one or more first criteria include a criterion that is satisfied when the electronic device detects a rising magnitude of touch at a first touch sensor of the one or more touch sensors, followed by a falling magnitude of touch at the first touch sensor.

13. The electronic device of claim 11, wherein the one or more programs further include instructions for:
determining a touch acceleration state from the position information; and
determining a force acceleration state from the force sensor data.

14. The electronic device of claim 13, wherein:
the one or more second criteria include a criterion that is satisfied in accordance with a determination that the touch acceleration state is in a deacceleration state prior to a determination that the force acceleration state is in an acceleration state.

15. The electronic device of claim 13, wherein the one or more second criteria include a criterion that is satisfied in accordance with a determination that the force acceleration state is in an acceleration state prior to a determination that the touch acceleration state is in an acceleration state.

16. The electronic device of claim 13, wherein the one or more first criteria include a criterion that is satisfied in accordance with a determination that the force acceleration state is in a deacceleration state prior to a determination that the touch acceleration state is in an acceleration state.

17. The electronic device of claim 13, wherein the one or more first criteria include a criterion that is satisfied in accordance with a determination that the touch acceleration state is in an acceleration state prior to a determination that the force acceleration state is in an acceleration state.

18. The electronic device of claim 11, wherein the one or more or programs further include instructions for:
determining a spatial center of the first input based on the position information; and
wherein the one or more first criteria include a criterion that is not satisfied in accordance with a determination that a magnitude of a first touch sensor of the plurality of touch sensors on a first side of the spatial center of the first input is decreasing and a magnitude of a second touch sensor of the plurality of touch sensors on a second side of the spatial center of the first input, different from the first side, is decreasing.

19. The electronic device of claim 11, wherein the one or more programs further include instructions for:
while performing the scroll operation:
in accordance with a determination that one or more touch sensors of the plurality of touch sensors associated with an edge portion of the input interface receives a decreasing touch signal, continuing the scrolling operation.

20. A non-transitory computer readable storage medium storing one or more programs, the one or more programs comprising instructions, which when executed by one or more processors of an electronic device comprising an input interface, wherein the input interface includes a plurality of touch sensors and a force sensor, cause the electronic device to perform a method comprising:
in response to receiving a first input at the input interface:
obtaining position information of the first input from the plurality of touch sensors;
obtaining force sensor data based on the first input from the force sensor;
in accordance with a determination that the force sensor data and the position information satisfy one or more first criteria, performing a scroll operation at the electronic device; and
in accordance with a determination that the force sensor data and the position information satisfy one or more second criteria, different from the first criteria, performing a press operation at the electronic device.
